(19) United States
(12) Patent Application Publication
(10) Pub. No.: US 2010/0217977 A1
(43) Pub. Date: Aug. 26, 2010

(54) SYSTEMS AND METHODS OF SECURITY FOR AN OBJECT BASED STORAGE DEVICE

(76) Inventors: William Preston Goodwill, Edmond, OK (US); Dave B. Anderson, Minnetonka, MN (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(21) Appl. No.: 12/390,956

(22) Filed: Feb. 23, 2009

(51) Int. Cl. H04L 9/00

(52) U.S. Cl. 713/167

(57) ABSTRACT

The disclosure is related to systems and methods of security for a data storage device and in particular embodiments, an object based data storage device. In a particular embodiment, a system comprises an object based data storage device adapted to store objects received from a host The object based data storage device may be adapted to encrypt and decrypt objects without allowing access to an encryption key or decryption key from external to the object based data storage device.

### FIELD OF THE DISCLOSURE

The present disclosure is generally related to security for a data storage device. Further, the present disclosure is also related to systems and methods of security for an object based data storage device.

### BRIEF DESCRIPTION OF THE DRAWINGS

FIG. 1 is a diagram of an illustrative embodiment of a system for implementing security on an object based data storage device;

FIG. 2 is a diagram of another illustrative embodiment of a system for implementing security on an object based data storage device; and

FIG. 3 is a diagram of another illustrative embodiment of a system for implementing security on an object based data storage device.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

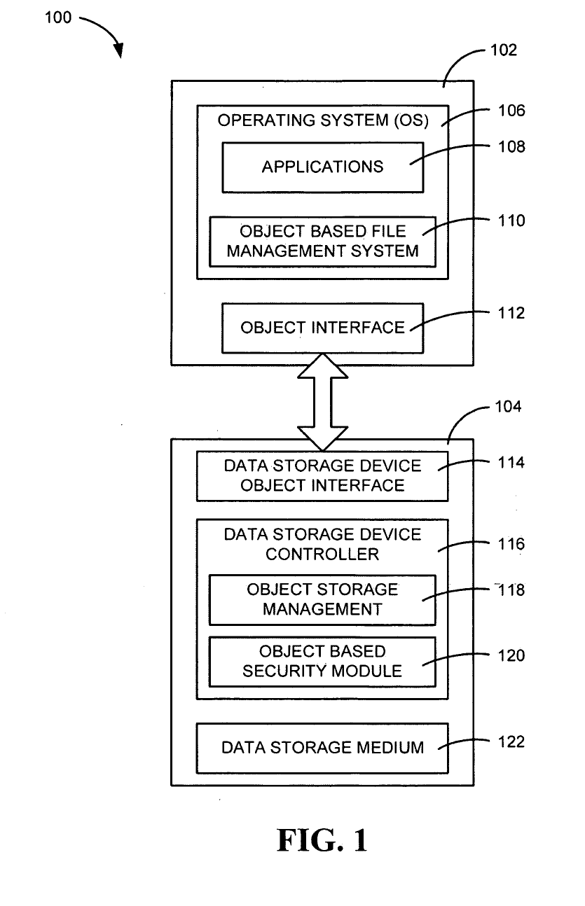

Referring to FIG. 1, a particular embodiment of a system for implementing security on an object based data storage device is shown and generally designated 100. The system 100 can include a host 102 coupled to an object based data storage device 104. The host 102 may comprise any form of computing device, such as a desktop computer, a server, a laptop computer, a telephone, a music player, a video player, a scanner, or any type of hand held computing device. The host 102 may include an operating system 106 that can run applications 108 and includes an object based file management system 110. The host 102 also can include an object interface 112 to transmit commands and data to the object based storage device 104 in an object based storage format.

In a particular embodiment, the host 102 and the object interface 112 transmits data, metadata, and attribute data identifying at least one attribute of the data as an object, or group, to the object based data storage device 104. In return, the object based data storage device 104 transmits a unique object based storage identifier to the host 102. The unique identifier is associated with each object rather than the underlying data, metadata, or attribute data. For example, the metadata may include information to identify the data associated with a particular object. The attribute data may include information identifying a filename, a file type, a level of importance of the data, a minimum quality of storage needed, a level of importance of the object, the size of the object, a user name, a host identifier, a time the object was created, a time the object was accessed, a time the object was modified, the number of times the object has been accessed, or a timer value.

The object based data storage device 104 can include a data storage device object interface 114, a data storage device controller 116, and a data storage medium 122. The data storage device controller 116 may include an object storage management module 118 and an object based security management module 120. As used herein, the term “module” may refer to hardware circuits, logic, firmware stored on a data storage medium, or any combination thereof.

In a particular embodiment, the object based security management module 120 may include an encryption module and a decryption module. The encryption module may be adapted to encrypt objects according to an encryption key. The decryption module may be adapted to decrypt an encrypted object. In addition, the object based security management module 120 may include an encryption key generation module adapted to generate encryption keys internally to the data storage device 104. The object based security management module 120 may encrypt each object based on a unique encryption key or may encrypt multiple objects based on a single encryption key.

The encryption keys may be stored in a secure memory area of the data storage device 104. The secure memory area may be a secure area of data storage medium 122, such as a security partition that has a restricted access to restrict the host from accessing the security partition. Also, the secure memory area may be completely hidden from the host 102 and the operating system 106. In a particular embodiment, the data storage medium 122 comprises a magnetic disc having at least one secure memory area, such as a secure partition, for storing the encryption key.

When a write command is received from the host 102, the object based security module 120 may encrypt an object associated with the write command. The object storage management module 118 may then store the encrypted object to the data storage medium 122. The encryption of the object may be done without transmitting the encryption key or a related decryption key external to the object based data storage device 104. The encryption of the objects by the object based security management module 120 can occur independent of any command received from the host; and in a particular embodiment, the host is completely unaware of the encryption of the objects by the object based storage device 104. Further, the object based security module 120 may encrypt the objects regardless of whether or not the objects received from the host were already encrypted.

When a read command containing a unique object based storage identifier is received from the host 102, the object storage management module 118 may retrieve the encryption key and the encrypted object from the data storage medium 122. Once the encryption key and the encrypted objected is retrieved, the object based security management module 120 may decrypt the encrypted object based on the encryption key to produce the original object. Once decrypted, the data storage device controller 116 may provide the object to the data storage device object interface 114 for transfer to the host 102.

In another particular embodiment, when a command is received from the host 102 to delete a selected object, the data storage device controller 116 may, instead of actually deleting the selected object, delete an encryption key associated with the selected object stored in the memory and notify the host 102 that the selected object was deleted. In another embodiment, when a command is received from the host 102 to delete multiple objects, the data storage device controller 116 may, instead of deleting the multiple objects, delete one or more encryption keys associated with the multiple objects and notify the host that the multiple objects were deleted.

In another embodiment, the object based security management module 120 may delete the encryption key from the memory in response to a trigger condition. The trigger condition may be a number of invalid password access attempts, a detected hacking attempt, an unauthorized command, a detection of inconsistent commands from the host, a detection of an unauthorized host, a detection of an unauthorized user, a time expiration, a change in programs executed at the host, or any combination thereof.

In a particular embodiment, the attribute data or the metadata may contain a timer value to indicate when the object is to be automatically deleted from the object based data storage device 104 without a delete command being received from the host 102. In another particular embodiment, the attribute data or the metadata may contain a timer value to indicate when the object is to be automatically retrieved from the data storage medium 122 and sent to the host 102 without a read command being received from the host 102. In yet other embodiments, a timer value could be included in the metadata or the attribute data to identify when any function internal to the object based data storage device 104 is to be executed for a particular data object.

In another embodiment, the object based security module 120 may include a random number generator. The random number generator may be hardware or software based. For example, the random number generator may be hardware that determines a position error signal (PES) of a servo controlled device. In another example, the random number generator may be an application specific integrated circuit (ASIC) adapted to generate a random number. The encryption key generation module may generate encryption keys at least partially based on the random number generator. In a particular embodiment, the object based security module 120 may generate the encryption key based on a user supplied password and the random number generator. In another embodiment, the encryption key may be based on a user supplied password combined with a data storage device unique key. For example, the data storage device unique key may be a key based on specific hardware of the data storage device, such as an ASIC-unique hidden root key.

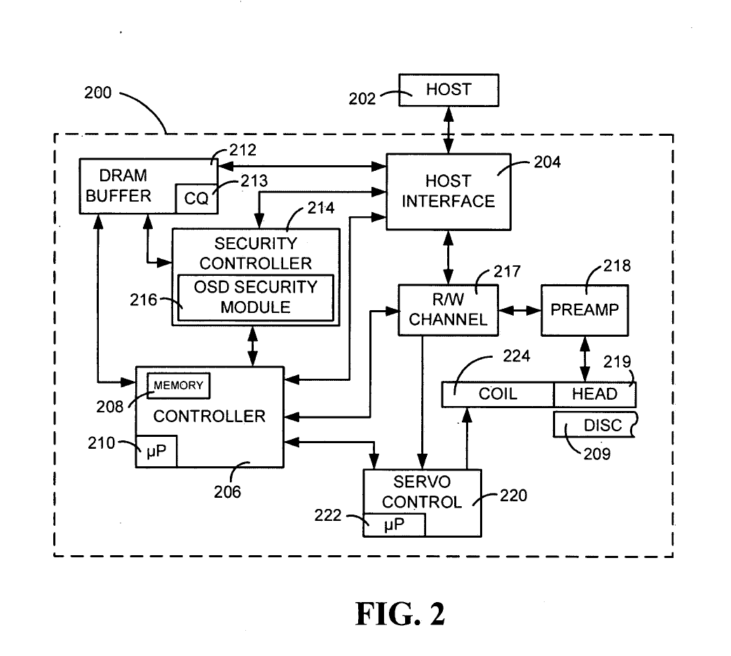

Referring to FIG. 2, a particular embodiment of a data storage device is shown and generally designated 200, the data storage device 200 may be used as the data storage device 104 shown in FIG. 1. As shown, the data storage device 200 can include disc(s) 209 for a data storage medium, however, other types of data storage mediums may be used in addition to or as a replacement for the disc(s) 209. For example, the disc(s) 209 may be accompanied by or replaced by solid state non-volatile memory, such as flash memory. The data storage device 200 can communicate with a host device 202 (such as the computer system 102 shown in FIG. 1) via a hardware and firmware based interface circuit 204. In a particular embodiment, the interface circuit 204 and the host 202 communicate via an interface protocol that enables object based storage functionality.

The data storage device 200 can include a programmable controller 206 with associated memory 208 and processor 210. The programmable controller 206 may be coupled to a buffer 212 that can temporarily store user data during read and write operations and can include a command queue (CQ) 213 where access operations can be temporarily stored pending execution.

Further, FIG. 2 shows the data storage device 200 may include a read/write (R/W) channel 217 which encodes data during write operations and reconstructs user data retrieved from disc(s) 209 during read operations. A preamplifier/driver circuit (preamp) 218 can apply write currents to head(s) 219 and can provide pre-amplification of readback signals. A servo control circuit 220 may use servo data to provide the appropriate current to the coil 224 to position the head(s) 219. The controller 206 can communicate with a processor 222 to move the head(s) 219 to the desired locations on the disc(s) 209 during execution of various pending commands in the command queue 213. However, the read/write circuitry and the addressing circuitry (such as servo control etc.) may be modified based on the type of data storage medium used. For example, in a solid state non-volatile storage device, write heads and a servo control circuit is not needed.

In a particular embodiment, the programmable controller 206 may also be coupled to a security controller 214. The security controller 214 may include a security key assignment module 216 that may be used to generate and manage assignment of security keys for data stored on the discs 209 or on another data storage medium, such as flash memory (not shown). The security controller 214 may also include a random key generator (not shown). In a particular embodiment, the security controller 214 may be combined with the programmable controller 206. The security controller 214 may be implemented using any combination of hardware or software.

During operation, the host 202 may transmit a write command and data, metadata, and attribute data identifying at least one attribute of the data as an object, or group, to the data storage device 200. In return, the data storage device 200 transmits a unique object based storage identifier to the host 202, the unique identifier associated with each object rather than the underlying data, metadata, or attribute data.

The host interface 204 can receive the write command and associated object and store the object to the buffer 212 and place the write command into the command queue 213. The host interface 204 may also provide information about the write command and object to the security controller 214. The security key assignment module 216 of the security controller 214 may be configured to generate or associate an encryption key with the object.

In a particular embodiment, the security key assignment module 216 may generate a security key at least partially based on the random number generator. The random number generator may be within the storage device 200 and can be hardware and/or software based as described with respect to FIG. 1 and elsewhere.

Further, the security key assignment module 216 may encrypt the object according to the encryption key and store the encryption key to a security area within the data storage device 200. The security area may also be a secure memory area, such as a security partition of disc(s) 209, that has a restricted access to restrict the host from accessing the security partition. The security area could also be a secure memory area of a non-volatile solid state memory, such as flash memory.

Once the object is encrypted, the controller 206 may store the encrypted object to the disc(s) 209. The data storage device 200 may encrypt the object and store it without transmitting the encryption key or a decryption key external to the data storage device 200. A second object received from the host 202 may then be encrypted and stored to the disc(s) 209 using a different, unique encryption key or the same encryption key as a previous object.

When a read command having a unique object identifier is received at the interface 204 from the host 202, the controller 206 may retrieve the associated encrypted object from the disc(s) 209. The security controller 214 may retrieve the encryption key from the memory and decrypt the encrypted object to produce the object as it was previously received from the host 202. Once decrypted, the controller 206 may provide the object to the host 202 via the interface 204.

The encryption and decryption of the objects by the data storage device 200 can occur independent of whether the object has been encrypted by the host and independent of any command received from the host. In a particular embodiment, the host 202 does not receive any information regarding the encryption and decryption of objects by the data storage device 200; the encryption and decryption of the object can be done transparently from the host's 202 perspective.

In another particular embodiment, the controller 206 may, in response to a command received from the host 202 to delete a selected object, delete an encryption key associated with the selected object, and notify the host 202 that the selected object was deleted, whether or not the selected object was actually deleted. Deletion of the encryption key should make the underlying data of the selected object unusable whether or not the selected object is actually deleted. This may be referenced as “shredding” an object. However, the data storage device 200 may choose to delete the selected object when time and resources are available.

In another embodiment, more than one object can be shredded at once when one encryption key is associated with multiple encrypted objects. Thus, the deletion of the encryption key should make all objects associated with the deleted encryption key unusable. This may be particularly useful when the host 202 or the data storage device 200 needs to delete all objects stored in a particular area quickly. For example, the data storage device 200 may, in response to a command received from the host 202 to delete the multiple objects, delete the encryption key associated with multiple objects and notify the host 202 that the multiple objects were deleted. The notification to the host 202 can occur prior to any actual deletion of the multiple objects from a data storage medium.

In a particular embodiment, the host 202 may send a command to the data storage device 200 to delete all of the objects stored on the data storage device. This may be a format command or a re-purpose command. When such a command is received, the data storage device 200 may delete all of the encryption keys associated with the objects from the host and notify the host 202 that the command was completed. This can provide a quick and efficient method to allow a host to delete all objects on a storage device. When an encryption key is deleted, the storage device may overwrite the encryption key multiple times depending on the level of assurance needed in the deletion.

A level based encryption key structure may be used to implement the ideas described herein. In one example, the data storage device 200 may store a master encryption key that is used to encrypt the object level encryption keys. If the master encryption key were to be deleted, then the object level encryption keys would be unusable. This type of level based encryption keys could be implemented for the whole data storage device 200, per partition or area, or based on any other method of grouping the objects. Thus, there could be two or more levels of encryption keys used.

For example, the objects may include an attribute identifier signifying a level of importance for the data. This may allow the data storage device 200 to select from multiple mid-level encryption keys to encrypt the selected object level encryption keys based on the level of importance for each selected object. For instance, there may be two importance levels related to the objects, high and low, that determine whether the object level encryption keys are encrypted by a first mid-level encryption key for high level of importance objects or a second mid-level encryption key for low level of importance objects. To shred all of the high level of importance objects at once, the data storage device 200 may delete the first mid-level encryption key. The data storage device could then still use the object level encryption keys that were encrypted by the second mid-level encryption key. In addition, the data storage device 200 may also have a master level encryption key to encrypt both the first and second mid-level encryption keys; thus, allowing for all encrypted objects to be rendered unusable with deletion of the master level encryption key. Any number of levels of encryption keys may be used.

In another embodiment, the security controller 214 may delete an encryption key in response to a trigger condition. The trigger condition may be a number of invalid password access attempts, a detected hacking attempt, an unauthorized command, a detection of inconsistent commands from the host, a detection of an unauthorized host, a detection of an unauthorized user, a time expiration, a change in programs executed at the host, or any combination thereof.

Although, the functions of the data storage device 200 are described with respect to security controller 214 and controller 216, the functions and hardware may be incorporated into one or more controllers in the data storage device 200. In addition, application specific integrated circuits, programmable logic arrays, and other hardware devices can be constructed to implement the functions described herein and, in particular, the functions described with respect to controller 214 and controller 216.

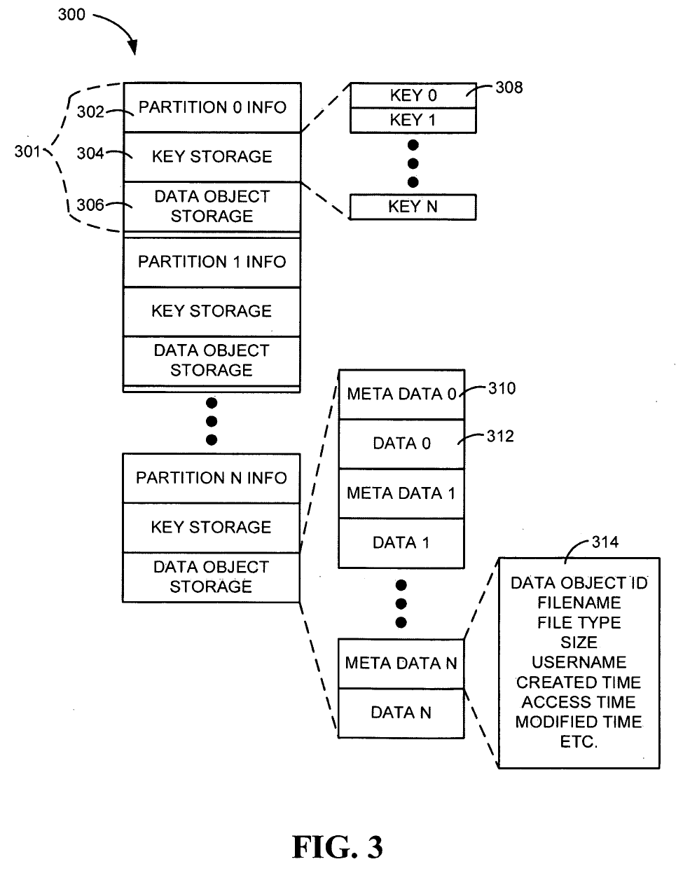

Referring to FIG. 3, a system for implementing security on an object based data storage device is depicted and generally designated 300. System 300 further depicts a block diagram representation of a configuration of a data storage medium to store encrypted objects, as described herein. The system 300 may be implemented on any type of storage device, though preferably a device having a non-volatile storage medium such as a magnetic disc or solid state memory.

System 300 can include a first partition 301 that includes a first area 302 for storing information related to the first partition 301, a second area 304 for storing one or more encryption keys 308 related to encrypted objects, and a third area 306 for storing the encrypted objects. A data storage medium may have one or more partitions similar to the first partition 301. The data storage device may decide which partition to store an object to based on an attribute of the object, allowing the storage device to intelligently group similar objects.

The third area 306 can store the encrypted objects which may include metadata 310 and user data 312. The metadata 310 may include information identifying attributes of the user data or the object. For example, the information may identify a unique object identifier, a filename, a file type, a level of importance of the data, a minimum quality of storage needed, a size of the object, a user name, a host identifier, a time the object was created, a time the object was accessed, a time the object was modified, the number of times the object has been accessed, a storage address, or a timer value. The timer value may be used by the data storage device to determine when to automatically delete the related object without subsequently receiving a delete command from the host.

In a particular embodiment, the second area 304 may be a secure partition designed to prevent access to the second area 304 by a host. In addition, the second area 304 may only be accessible with the use of an access key. When a data storage device determines to make all of the encrypted objects stored in the third area 306 unusable, the storage device can delete the access key to the second area 304 that stores all the encryption keys 308 for the encrypted objects. With the encryption keys inaccessible in the second area 304, the encrypted data objects will no longer be useable to retrieve the unencrypted data from.

Another embodiment of the system 300 may include a single secure area to store the encryption keys for the whole data storage device or multiple partitions. Deleting the encryption keys or rendering the encryption keys inaccessible in the single secure area can make all of the related objects on the storage medium inaccessible. This can provide a quick and efficient method to make all data on a storage device inaccessible or deleted from a host's perspective.

In accordance with various embodiments, the functions and methods described herein may be implemented as one or more software programs running on a computer processor or controller, such as the controller 116, the controller 214, or the controller 206. Dedicated hardware implementations including, but not limited to, application specific integrated circuits, programmable logic arrays and other hardware devices can likewise be constructed to implement the functions and methods described herein. The systems and methods described herein are particularly useful for data storage devices having nonvolatile memory; however, the systems and methods described herein can be applied to any type of data storage system.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A device comprising:
an object based data storage device adapted to store objects received from a host, where each object comprises user data, metadata, and data identifying an attribute of the object, the object based data storage device adapted to encrypt and decrypt objects without transmitting an encryption or decryption key external to the object based data storage device, the object based data storage device comprising:
an interface adapted to receive an object from the host, assign a unique identifier to the object, and transmit the unique identifier back to the host;
an encryption module coupled to the interface and adapted to encrypt a selected object to produce an encrypted object based on an encryption key;
a controller coupled to the encryption module, a memory, and a data storage medium, the controller adapted to:
store the encrypted object to the data storage medium and store the encryption key to the memory;
retrieve the encryption key from the memory and the encrypted object from the data storage medium when a read command containing a unique identifier associated with the selected object is received from the host; and
a decryption module coupled to the controller, the decryption module adapted to decrypt the encrypted object based on the encryption key to produce the selected object and provide the selected object to the interface for transfer to the host.

2. The device of claim 1 wherein the encryption and decryption occurs independent of any command from the host and the encryption key is not provided from the data storage device to the host.

3. The device of claim 1 wherein the selected object is not encrypted when received from the host at the interface, the selected object is encrypted when stored on the data storage medium, and the selected object is not encrypted when provided back to the host.

4. The device of claim 1 wherein the selected object is already encrypted with a first encryption when received from the host at the interface, the selected object is encrypted a second time with a second encryption by the encryption module, the selected object with the second encryption is stored on the data storage medium, and the selected object is only encrypted with the first encryption when provided back to the host.

5. The device of claim 1 further comprising the controller adapted to, in response to a command received from the host to delete the selected object, delete the encryption key stored in the memory instead of deleting the encrypted object stored on the data storage medium, and notify the host via the interface that the selected object was deleted.

6. The device of claim 5 further comprising the controller adapted to delete the encryption key in response to a trigger condition being detected.

7. The device of claim 6 wherein the trigger condition comprises at least one of a number of invalid password attempts, a detected hacking attempt, an unauthorized command, detection of inconsistent commands from the host, detection of an unauthorized host, detection of an unauthorized user, a time expiration, and a change in programs executed at the host.

8. The device of claim 1 further comprising the encryption module adapted to encrypt multiple objects based on a single encryption key; and the controller adapted to, in response to a command received from the host to delete the multiple objects, delete the single encryption key, not delete the encrypted objects from the data storage medium, and notify the host via the interface that the multiple objects were deleted.

9. The device of claim 1 further comprising the encryption module adapted to encrypt multiple objects, each object being encrypted based on a unique encryption key; and the controller adapted to, in response to a command received from the host to delete the multiple objects, delete each unique encryption key associated with the multiple objects, not delete the encrypted objects, and notify the host via the interface that the multiple objects were deleted.

10. An object based data storage device comprising:
an interface adapted to receive an object from a host, each object comprising user data, metadata, and data identifying an attribute of the object, the interface further adapted to provide a unique identifier that is associated with the object to the host;
a controller coupled to the interface and comprising a security module adapted to:
encrypt the object based on an encryption key to produce an encrypted object;
store the encrypted object to a data storage medium;
store the encryption key to a memory; and
delete the encryption key stored in the memory in response to a trigger without decrypting the encrypted object stored on the data storage medium.

11. The object based data storage device of claim 10 further comprising the data storage medium, wherein the data storage medium is at least one of a magnetic disc, a magneto-optical disc, an optical disc, or a solid state non-volatile memory.

12. The object based storage device of claim 10 further comprising the controller comprising a decryption module adapted to decrypt the encrypted object based on the encryption key to produce the object and provide the object to the interface for transfer to the host.

13. The object based data storage device of claim 12 further comprising multiple objects and the controller is further adapted to encrypt each of the multiple objects based on a unique key associated with each of the multiple objects.

14. The object based data storage device of claim 13 wherein each of the unique encryption keys are stored in a secure area of the object based data storage device, the secure area being configured to restrict access to the secure area from external to the object based data storage device.

15. The object based data storage device of claim 13 wherein the attribute comprises a designation of a level of importance for each of the multiple data objects and the controller is further adapted to:
when a first level of importance is designated by the attribute, encrypt each of the unique encryption keys associated with objects having the first level of importance using a first encryption key;
when a second level of importance is designated by the attribute, encrypt each of the unique encryption keys having the second level of importance using a second encryption key; and
encrypt both the first encryption key and the second encryption key using third encryption key.

16. The object based data storage device of claim 10 wherein each of the unique encryption keys are stored in a secure area of the object based data storage device, the secure area configured to restrict access to the secure area from external to the object based data storage device.

17. A controller comprising:
an encryption module adapted to:
generate an encryption key that is not accessible by a host and is based upon a random number from a random number generator;
encrypt an object intended for storage on an object based data storage device, the encrypting based on an encryption key to produce an encrypted object;
a data storage module adapted to:
store the encrypted object to a data storage medium;
store the encryption key to a memory;
retrieve the encrypted object from the data storage medium when a read command is received from a host, the read command including a unique object based storage identifier;
retrieve the encryption key from the memory;
a decryption module adapted to:
decrypt the encrypted object based on the encryption key to produce the object;
a deletion module adapted to:
delete the encryption key stored in the memory in response to a trigger; and
notify the host that the object has been deleted from the object based data storage device.

18. The controller of claim 17 wherein the trigger comprises a timer value associated with the object, the timer value indicating when the object is to be automatically deleted without a delete command being subsequently received from the host.

19. The controller of claim 20 further comprising the random number generator.

20. The controller of claim 19 further comprising the encryption module adapted to generate the encryption key based on a user supplied input and the random number generator.
